(19) United States
(12) Patent Application Publication
(10) Pub. No.: US 2016/0158755 A1
(43) Pub. Date: Jun. 9, 2016

(54) CHIP FOR PRELIMINARY SAMPLE EVALUATION AND CELL COLLECTION

(71) Applicant: CYTOGEN CO., LTD., Gyeonggi-do (KR)

(72) Inventors: Byung Hee JEON, Seongnam-si (KR); Jong Kil LEE, Incheon (KR)

(21) Appl. No.: 14/905,651

(22) PCT Filed: Jul. 15, 2014
(86) PCT No.: PCT/KR2014/006339

§ 371 Date: Jan. 15, 2016

(30) Foreign Application Priority Data
Jul. 15, 2013 (KR) 10-2013-0083178

(51) Int. Cl. B01L 3/00

(52) U.S. Cl. CPC B01L 3/502753; B01L 2300/0681; B01L 2300/16; B01L 2200/0647

(57) ABSTRACT

Disclosed is a chip for preliminary sample evaluation and cell collection. The chip for preliminary sample evaluation and cell collection includes: a substrate having a first hole formed in a first position and a second hole formed in a second position, the second hole being smaller in size than the first hole; and a mesh filter installed on a lower surface of the substrate in alignment with the first hole, the mesh filter having a plurality of filtering holes. The chip is capable of preliminarily evaluating a state or a property of a sample. If the sample is unacceptable, it is possible to replace the entire sample with a new sample and to take an additional measure so that the sample becomes acceptable. If the sample is acceptable, the next process is performed to collect cells contained in the sample.

### TECHNICAL FIELD

The present invention relates to a chip for preliminarily evaluating a state or a property of a sample and for collecting cells contained in the sample if a result of evaluation is acceptable.

### BACKGROUND ART

In a basic method of inspecting cells contained in a sample, it is necessary to first collect cells to be inspected. The collection of cells is performed by different methods and different devices in conformity with the features of cells.

For example, Korean Patent Application Publication No. 10-2012-0047023 discloses a single-cell collecting device. Korean Patent Application Publication No. 10-2012-0130915 discloses a substrate structure for collecting a single cell and a method of manufacturing the same. Korean Patent Application Publication No. 10-2013-0067200 discloses a cell collecting filter for collecting a circulating tumor cell contained in blood.

### SUMMARY OF THE INVENTION

### Technical Problems

It is an aspect of the present invention to provide a chip for preliminary sample evaluation and cell collection capable of, at one step, preliminarily evaluating a state or a property of a sample using a part of the sample and capable of, at the next step, collecting inspection target cells contained in the entire sample if a result of evaluation is acceptable.

### Technical Solutions

According to one aspect of the present invention for achieving the above, there is provided a chip for preliminary sample evaluation and cell collection, including: a substrate having a first hole formed in a first position and a second hole formed in a second position, the second hole being smaller in size than the first hole; and a mesh filter installed on a lower surface of the substrate in alignment with the first hole, the mesh filter having a plurality of filtering holes.

Preferably, the substrate has a third hole formed in a third position, the third hole being smaller in size than the first hole and larger in size than the second hole.

### Advantageous Effects

The chip for preliminary sample evaluation and cell collection according to the present invention is capable of preliminarily evaluating a state or a property of a sample using only a small amount of the sample. This makes it possible to rapidly determine the acceptability of the sample. Thus, if the sample is unacceptable, it is possible to replace the entire sample with a new sample and to take an additional measure so that the sample becomes acceptable. Accordingly, if a part of the sample is determined to be unacceptable, a process of collecting cells from the entire sample need not be performed. This eliminates a possibility that a cell collecting process is unnecessarily performed without recognizing the unacceptability of the sample and, consequently, the sample is wasted it its entirety. If the sample is determined to be acceptable, the next process is performed to collect cells contained in the sample.

### BRIEF DESCRIPTION OF THE DRAWINGS

FIGS. 1A and 1B are top and bottom perspective views illustrating a chip for preliminary sample evaluation and cell collection according to one embodiment of the present invention.

FIGS. 2A and 2B are partially-cutaway sectional views taken along line A-A′ and line B-B′ in FIG. 1A.

FIGS. 3A and 3B are plan views illustrating chips for preliminary sample evaluation and cell collection according to other embodiments of the present invention.

### EMBODIMENTS

The above and other objects and features of the present invention will become apparent from the following description of preferred embodiments given in conjunction with the accompanying drawings.

Embodiments of a chip for preliminary sample evaluation and cell collection according to the present invention will now be described in detail with reference to the accompanying drawings.

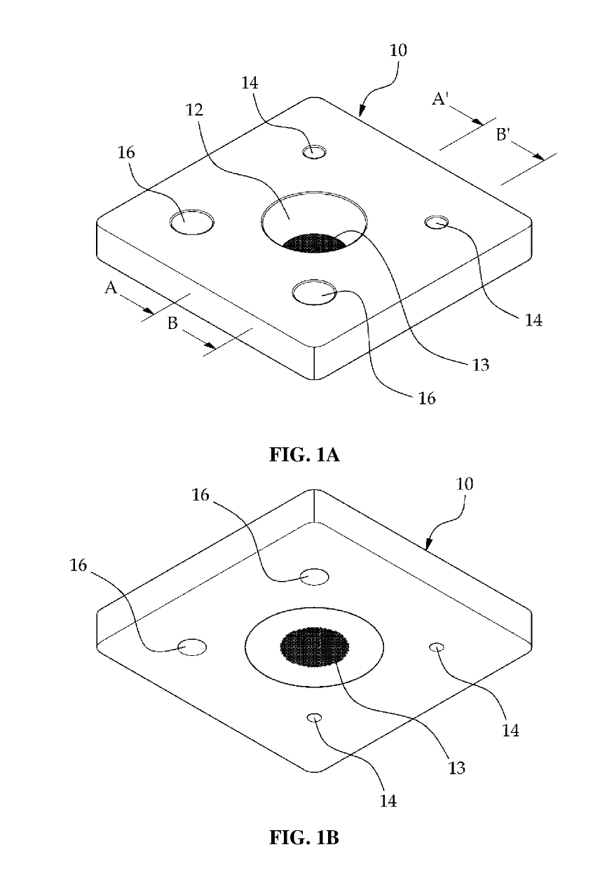

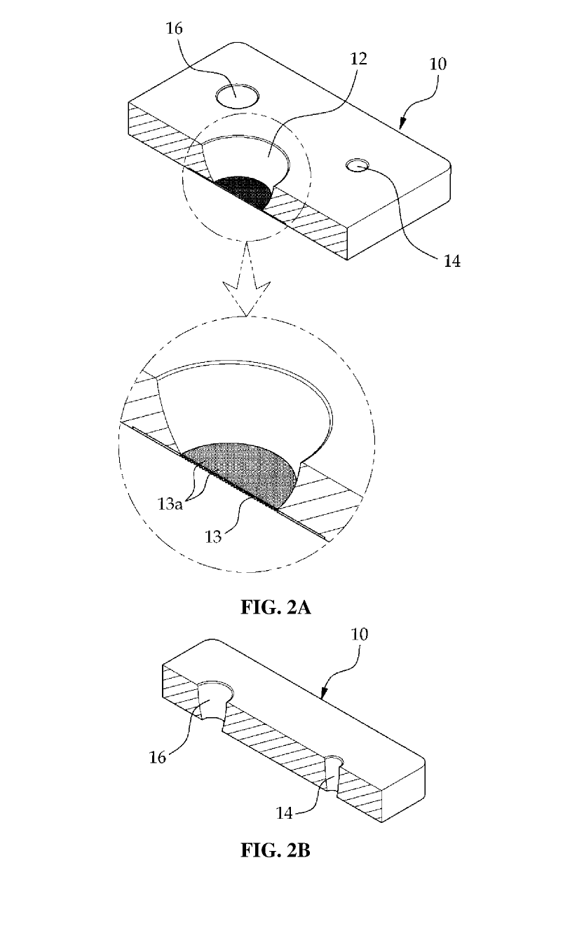

Referring to FIGS. 1A to 2B, the chip for preliminary sample evaluation and cell collection includes a rectangular substrate 10 serving as a body.

The substrate 10 has a first hole 12 formed in a central portion thereof. The first hole 12 has a diameter growing smaller from an upper portion of the first hole 12 toward a lower portion thereof. The first hole 12 is defined by a curved inner surface. A mesh filter 13 is fixedly secured to a lower surface of the substrate 10 so as to close a lower end of the first hole 12. The mesh filter 13 has a plurality of filtering holes 13a capable of filtering cells contained in a sample.

Referring again to FIG. 1A, the substrate 10 has second holes 14 formed at a right side of the first hole 12 and third holes 16 formed at a left side of the first hole 12. The second holes 14 and the third holes 16 are smaller in size than the first hole 12. The third holes 16 are larger in size than the second holes 14.

Similar to the first hole 12, each of the second holes 14 and the third holes 16 has a diameter growing smaller from an upper portion toward a lower portion. Each of the second holes 14 and the third holes 16 is defined by a curved inner surface. While not shown in the drawings, mesh filters may be installed on lower surfaces of the second holes 14 and the third holes 16. The surfaces of the mesh filters may be coated with an antibody or a reagent so as to easily collect cells contained in a sample.

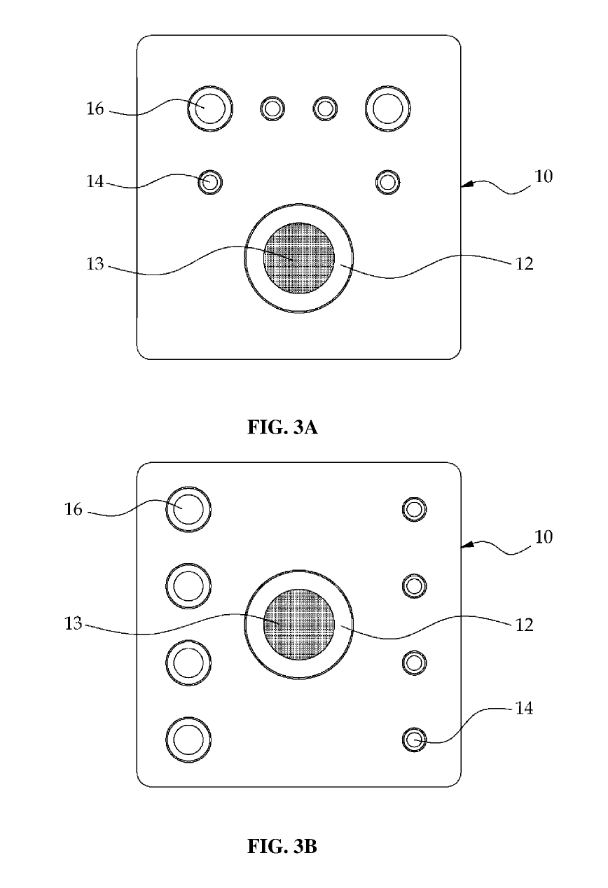

In other embodiments of the present invention, the size, position and number of holes may be appropriately selected in conformity with the property of a sample or the property of cells to be collected. FIGS. 3A and 3B illustrate chips for preliminary sample evaluation and cell collection according to other embodiments of the present invention.

Hereinafter, descriptions will be made on the operation of the chip for preliminary sample evaluation and cell collection according to the present invention, which has the configuration described above.

First, by use of a supply device which stores a sample containing cells to be collected, a small amount of sample is dropped into the second holes 14 or the third holes 16, whichever is selected depending on the property of a sample or the property of cells. The supply state, such as fluidity or the like, of the sample and the status of the sample dropped into the second holes 14 or the third holes 16 are preliminarily determined.

If the preliminary determination reveals that the state or the property of the sample is unacceptable, the entire sample is replaced by a new sample. If necessary, a preliminary step is performed again by adjusting the concentration of the sample to improve the fluidity of the sample. If the preliminary determination reveals that the state or the property of the sample is acceptable, the entire sample is supplied into the first hole 12 to collect all the cells contained in the sample. The liquid and fine particles of the sample supplied into the first hole 12 pass through the filtering holes 13a. The cells larger in size than the filtering holes 13a fail to pass through the filtering holes 13a. Thus, the cells are filtered and collected.

While embodiments of the present invention have been described above, the present invention is not limited to the aforementioned embodiments. It goes without saying that a person skilled in the relevant art can make various changes and modifications without departing from the scope of the invention defined in the claims. Such changes and modifications shall be construed to fall within the scope of the present invention.

### DESCRIPTION OF REFERENCE SYMBOLS

10: substrate, 12: first hole, 13: mesh filter, 13a: filtering holes, 14: second holes, 16: third holes

1. A chip for preliminary sample evaluation and cell collection, comprising:
a substrate having a first hole formed in a first position and a second hole formed in a second position, the second hole being smaller in size than the first hole; and
a mesh filter installed on a lower surface of the substrate in alignment with the first hole, the mesh filter having a plurality of filtering holes.

2. The chip of claim 1, wherein the substrate has a third hole formed in a third position, the third hole being smaller in size than the first hole and larger in size than the second hole.

3. The chip of claim 2, wherein each of the first hole, the second hole and the third hole has a diameter growing smaller downward.

4. The chip of claim 1, further comprising:
a mesh filter installed on the lower surface of the substrate in alignment with the second hole.

5. The chip of claim 1, wherein a surface defining the second hole is coated so as to easily collect cells.

6. The chip of claim 1, wherein each of the first hole, the second hole and the third hole has a diameter growing smaller downward.
